(19) United States
(12) Patent Application Publication
(10) Pub. No.: US 2004/0225626 A1
(43) Pub. Date: Nov. 11, 2004

(54) Automated meter reading installation system and method

(76) Inventor: Brian Forrester, Greer, SC (US)

Correspondence Address: McNair Law Firm, P.A., P.O. Box 10827, Greenville, SC, 29603-0827, US

(21) Appl. No.: 10/827,188

(22) Filed: Apr. 19, 2004

Related U.S. Application Data
(60) Provisional application No. 60/468,594, filed on May 7, 2003.

(51) Int. Cl. G06F 9/00

(52) U.S. Cl. 705/412

(57) ABSTRACT

A system and method for assisting in the installation of automated meter reading technology and more specifically, to the administrative tasks associated with replacing of traditional meter with meters allowing for automated readings. The invention allows a user to receive data concerning a utility meter upgrade from a host computer to a handheld device, input data concerning the upgrade on a handheld computer, and then transmit the data back to host computer, thus updating the information on the host computer.

### CROSS REFERENCE TO RELATED APPLICATION

This application claims priority from a provisional application filed May 7, 2003 under Serial No. 60/468,594 having the same title.

### FIELD OF THE INVENTION

This invention is directed to a system and method for assisting in the installation of automated meter reading technology and more specifically, to the administrative tasks associated with replacing of traditional meter with meters allowing for automated readings.

### BACKGROUND OF THE INVENTION

In the utility industry, utilities track the use of such resources as power, water, electricity and other utility services through metering devices that measure the amount of resource used by the consumer. For example, electricity is measured in kilowatt-hours where one kilowatt is equal to powering one 100-watt light bulb for 10 hours. As most are aware, meters are placed between the source of the resource provided and the consumer. The meter determines the use by the consumer and is subsequently “read” by a utility agent or utility employee. The reading is then used to calculate the invoice to be sent to the consumer for consumption of the resource. By way of example, the monthly use of electricity is determined to be 5000-kilowatt hours, this number is multiplied by the charge per kilowatt hour to calculate the amount owed from the consumer. In order to determine the monthly invoicing for the consumer, the meter for each and every consumer needs to be read monthly. As meters are typically installed in close proximity to the structure in which the resource is used, the utility employee must travel to each meter location and physically view each and every meter monthly. Clearly, considerable time is taken to drive to each location, exit the vehicle, read the meter, return to the automobile and record the meter reading. To reduce the amount of time required to read meters, automated meter reading technology has been developed that allows the utility employee to merely drive to the meter location and through radio frequency (RF) transmissions, record the meter reading without leaving the vehicle. A RF device within the meter itself transmits the meter reading, upon request from another electronic recording device, so that the meter reading is automatically recorded without the utility employee having to physically travel to with a very close proximity of the meter. Simply, the meter can be read from the curb.

However, in order to take advantage of the automated meter reading technology, the traditional utility meters must be exchanged for a meter having the automated meter reading functionality. This process requires considerable record keeping, must be extremely accurate in recording the identification and location of the older traditional meter and the new meter, and generates significant administration issues as all meters should be exchanged within the same month so as not to disrupt the normal billing cycle. Previously, the utility employee traveled to the location having a traditional older meter, records the location and serial number, replaces the meter with a new meter having automated reading technology, records the serial number of the new meter, and return to the utility with this information. The utility then records the information by updating the customer account, adjusting meter inventory, associating the customer account with the new meter, and updating the automated meter reading system with the fact that the location now has a new meter. Any errors in this process result in the new meter being unable to be polled by the automated meter reading technology. For example, if the location is incorrect, the wrong customer account may be charged. If the serial numbers of the meters are recorded incorrectly, then the meter reading may not be proper associated with the customer or with the automated meter reading system. If the inventory of the new meters is not properly adjusted, the utility does not have an accurate account of the number of new meters and cannot properly schedule updates to traditional older meters.

Therefore, considerable attention needs to be given for a system and method for reducing errors in the new meter replacement process so that data integrity and customer account integrity are maintained while allowing a quick replacement of traditional meter to new meters.

Accordingly, it is an object of the invention to provide for an automated system for the replacement of outdated utility meter with new meters.

It is another object of this invention to provide for an automated system for assisting in the administrative tasks of replacement of utility meters with new meters that integrate into existing billing systems of the utility.

It is another object of this invention to provide for an automated system for assisting in the administrative tasks of identifying outdated utility meters and processing the replacement with new meters along with integrated customer information.

### SUMMARY OF THE INVENTION

The above objectives are accomplished by providing an automated system for exchanging customer meter information when upgrading utility meters from old meters to new meters to maintain accurate records of the upgrades. The system includes a portable computer readable medium; a host computer readable medium in communication with the portable computer readable medium; customer information embodied within said host computer readable medium containing current utility meter information and location information for customers; and a set of computer readable host instructions found in the host computer readable medium. Those instructions may include instructions for retrieving the current utility meter and location information for customers who have old utility meters that need to be changed to new meters; and for transmitting the retrieved current utility meter and location information to a portable computer readable medium. The invention may further contain a set of computer readable portable instructions found in the portable computer readable medium having instructions for receiving the retrieved current utility meter and location information from the host computer readable medium; instructions for receiving updated meter information concerning the replacement of a old utility meter with a new utility meter; and transmitting the updated meter information to the host computer readable medium. The set of host computer readable instructions may also include instructions for receiving the updated new meter information from the portable computer readable medium representing old meters changed to new meters, and instructions for receiving updating current utility information with updated meter information in the customer information on the host computer readable medium, to reflect updated change out status.

The set of host computer readable instructions may also include instructions for creating route information representing a list of locations where meters need to be changed with the route information arranged in a logical sequence based on location information. The set of host instructions may include instructions for transmitting route information to a portable computer readable medium; converting the route information to a format recognizable by a portable computer readable medium prior to transmitting the route information to the portable computer readable medium; or displaying route information. The set of portable instructions may include instructions for displaying a list of options; receiving input representing a selection of an option from a user; or displaying output in response to selection of an option. The receiving instructions may include scanning instructions for electronically scanning the updated meter information into the portable computer readable medium.

A method of performing the steps of the host and portable instructions is also provided according to the invention.

### DESCRIPTION OF THE DRAWINGS

FIG. 1 is a schematic illustrating components used with this invention.

FIG. 2 is a flowchart of the invention from the billing system's point of view.

FIG. 3 is a flowchart of the invention from the handheld device's point of view.

### DETAILED DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

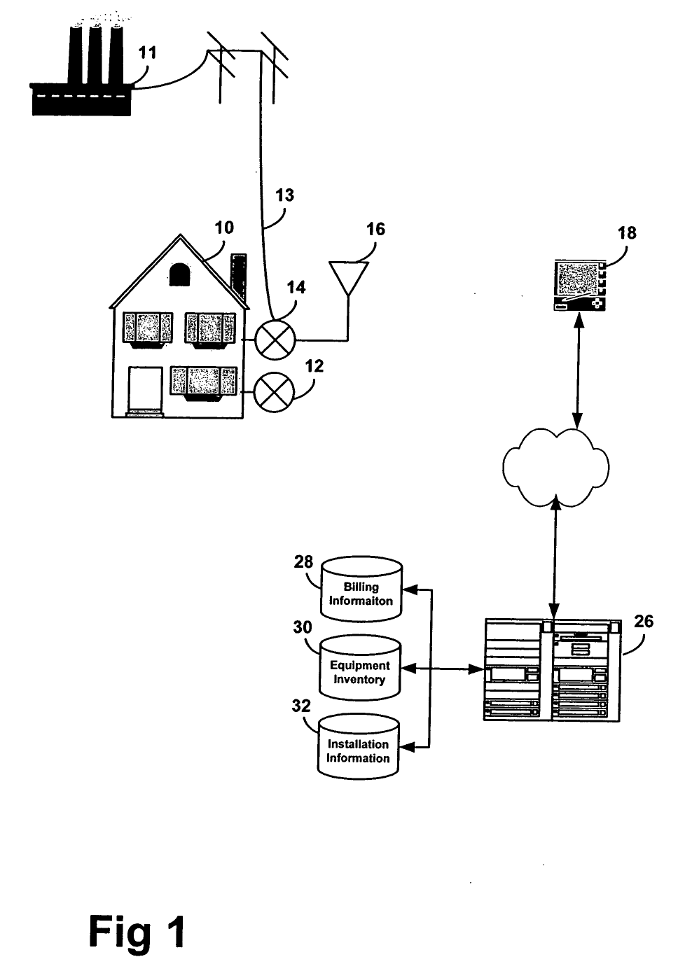

Referring now to FIG. 1, the consumer of utility services 10 receives services from utility 11. The services are delivered through delivery means 13 that are then measured through traditional meter 12. When the utility wishes to replace the traditional meter with one capable of automated-meter reading technology, new meter 14 is installed at consumer location 10 and traditional meter 12 is removed. New meter 14 includes a transmission means 16 for transmitting the meter reading upon request for determining the consumption of the consumer for that particular utility service.

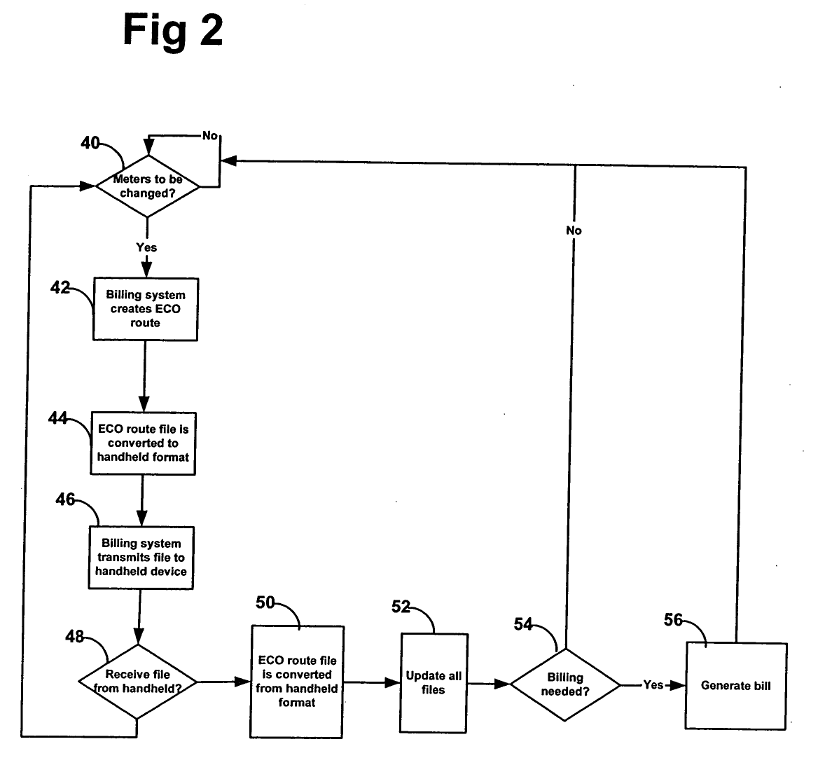

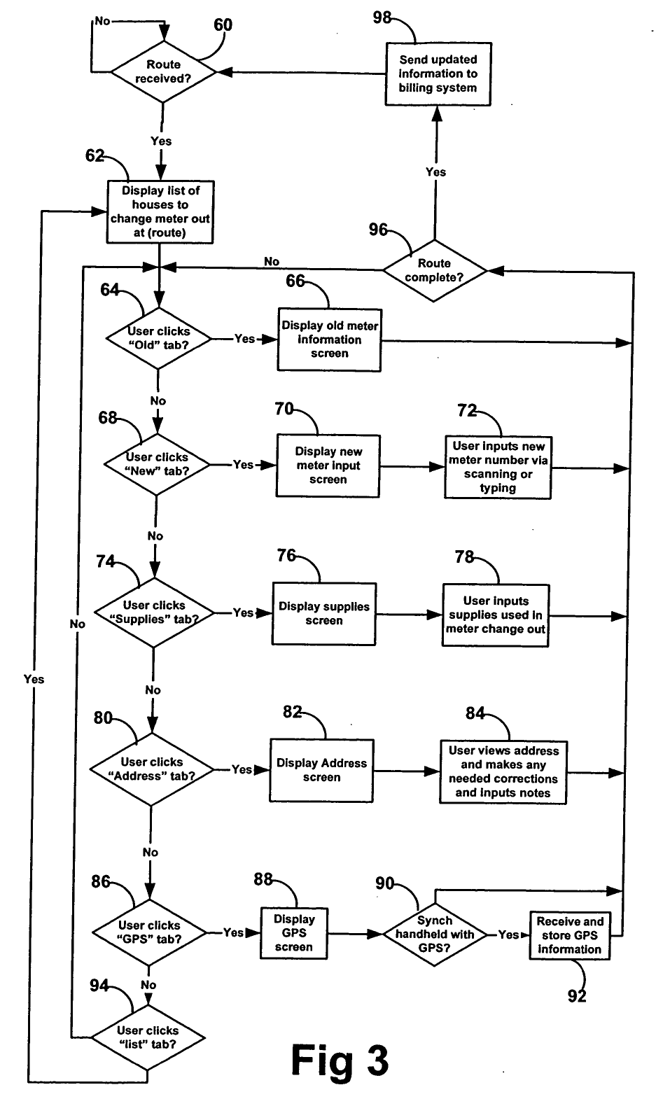

When the time comes to replace old meter 12 with new meter 14, billing system 26 creates a listing of meters including meter 12 that need to be replaced. This listing is transmitted via network 22 to handheld device 18. This process is defined more clearly by the flowcharts of FIGS. 2 and 3.

FIG. 2 is a flowchart detailing the operation of the system during a change-out of an old meter to a new meter from the billing system's point of view. The billing system first determines if there are meters outstanding that need to be changed at step 40. If no meters need to be changed the system continues to loop until it determines that there are meters that need to be changed. If there are meters that need to be changed at step 40, the billing system creates an electronic change-out route in step 42. This route is a listing of locations where old meters need to be changed. The billing system, knowing the addresses and locations of the meter, is able to create a fast route for the technician that is changing the meters out to follow. Once the route is created the billing system converts the file containing this information into a file that is readable by handheld devices. Note that in alternative embodiments the billing system could create the route file in a format that is already readable by handheld devices and thus, this step could be omitted. However, in the preferred embodiment a conversion step is necessary as most billing software does not produce files that are readable by handheld devices. This billing system then transmits the file to the handheld device at step 46. Note that in alternative embodiments an intermediate system can be used to transmit the file. This transmission can occur in one of several different ways. The transmission could be a wireless send to a handheld device which receives and downloads the information. The communication could occur when the handheld device is synched-up to a computer that is in communication with the billing system. At step 48 the system determines if it has received a file from one of the associated handheld devices. If it has not received a file then it continues to create new lists of meters to be changed out. If a file has been received from the handheld device at step 48 then the system retrieves the file and converts the file into a format that is readable by the billing system software at step 50. Upon converting the file the billing system then updates all of its files and records according to the information that has been transmitted from the handheld device. This information should include that the meter has been changed out correctly, and thus, the system would remove this meter from its need to be changed out list. The billing system then determines if any new billing is needed at step 54. If no new billing is needed, the system returns to step 40 where it continues to determine if any old meters exist that need to be changed. However, if a billing is necessary at step 54, the system will generate a bill at step 56 before returning to step 40. In certain situations a billing will be necessary for any supplies used during a meter change out. While many utilities will choose not to bill for the meter used or for the supplies used in changing out the meter, this option is necessary as some utilities may desire to pass along the costs of changing the meters and using supplies to change meters to their customers directly rather through heightened energy costs.

Referring now to FIG. 3 the process of updating a meter is shown through a flowchart from the point of view of the handheld device. If the handheld device receives a route file at step 60, then the system displays a list of the locations that need meters changed out at step 62. The screen that shows the listing of locations also contains tabs at the bottom of the screen. These tabs include lists which is the page we are currently viewing, old, new, supplies, address, and GPS tabs. If the user clicks on the old tab at step 64, the handheld device will display the old meter information screen at step 66. The old meter display screen contains the serial number of the old meter and the reading on the old meter that can be used to determine the amount of energy that has been used thus far this month. Once the user of the handheld device has verified that he is at the proper location and dealing with the proper meter, he may begin changing out the meter. The user has not completed the route at step 96 so the system continues back to step 64. As the user is already viewing the old tab screen they would not click the old tab at step 64. At step 68, the user would click the new tab and go onto step 70 where the new meter input screen is shown. At this point, the user of the handheld device would input the number associated with the new meter into the handheld device at step 72. In a preferred embodiment the handheld device will contain a scanning member that will be used to scan in the number that is on the meter that is being installed. The use of this scanning technology insures that there is no human error in inputting the number associated with the new meter. Once the user has input the new meter number via scanning at step 72, the route remains incomplete at step 96, the user has no need to click the old tab 64 or the new tab 68 thus the user goes on to click the supplies tab at step 74. By clicking on this tab, the supply screen is displayed at step 76. This screen allows the user to input any supplies they used in changing out the meter. Oftentimes no supplies will be needed beyond the meter that was actually used to be changed out, however, sometimes various supplies will be used in the installation process. It is advantageous to have a record of these supplies for billing purposes and inventory purposes. Thus, these are input at step 78. As the route remains to be completed at step 96, the system advances through to where the user has the option of clicking on one of the tabs. As the user would not click on the old tab, new tab, or supplies tab the next logical tab to click on would be the address tab at step 80. Once the user has clicked on the address tab the address screen is displayed at step 82. From this screen the user, at step 84, can view the address of the location he is at and make any needed corrections to this listing, and input any notes he needs to make for this address. The ability to input notes is an additional functionality of the invention. If the meter is not able to be changed out the user of the handheld device needs to input appropriate information into the system so that the same errors that led to not being able to change out the meter are not made again. Further, if while at the site of the meter change out the user of the system notices a problem with utility or if the customer tells the user of a problem with their utility service, then the user may input this information into the notes section of the screen. These notes, upon transmission to the billing system, will be viewed by someone who is able to either rectify the problems that have been input into the notes section or notify someone to rectify these problems. Once the user has finished inputting notes at step 84, if the route is still incomplete at step 96, then the user may again click on one of the tabs listed above. If the user clicks on the GPS tab at step 86 the GPS screen will be displayed at step 88. If the user decides to synch the handheld with the GPS at step 90, then at step 92 the handheld device will receive and store GPS information. If the user chooses not to synch the handheld with the GPS system then the system returns to step 96 to determine if the route is complete. The use of GPS synching is important in verification of the location of a meter. At this point, the user of the handheld has finished changing out a meter at a location. If the user has not completed his route at step 96 he continues through the list of houses displayed at step 62 until he has finished his route. If the user has finished his route at step 96, then the user will send updated information from this hand held to the billing system at step 98. This transmission can occur through a variety of ways including wireless transmission and the synching of a handheld device to a computer that has a connection to the billing system.

Note that while discussion of upgrading meters in the preferred embodiment comprised mainly changing the existing meter with a completely new meter, it is possible in alternative embodiments to upgrade the old meter without changing out the meter completely. This would be achieved by adding an additional component to the existing meter that would transmit readings from the meter to an associated device.

While a preferred embodiment of the invention has been described using specific terms, such description is for illustrative purposes only, and it is to be understood that changes and variations may be made without departing from the spirit or scope of the following claims.

What is claimed is:

1. An automated system upgrading utility meters from old meters with traditional meter reading capabilities to new meters with automated meter reading capabilities and maintaining accurate records of the upgrade comprising:
a first computer readable medium;
a host computer readable medium with the ability to transmit data to and from said first computer readable medium;
customer information embodied within said host computer readable medium containing current utility meter information and location information for customers;
a set of computer readable host instructions embodied within said host computer readable medium including:
retrieving instructions for retrieving said current utility meter and location information for customers who have old utility meters that need to be upgraded;
instructions for transmitting said retrieved current utility meter and location information to said first computer readable medium; and
a set of computer readable portable instructions embodied within said first computer readable medium including:
instructions for receiving said retrieved current utility meter and location information from said host computer readable medium;
instructions for receiving updated meter information concerning the upgrade of one of said old utility meters with a new utility meter or upgrading said old utility meters with additional components; and
instructions for transmitting said updated meter information to said host computer readable medium;
said set of host computer readable instructions including:
instructions for receiving said updated new meter information from said first computer readable medium representing upgraded old meters, and
instructions for updating said current utility information with said updated meter information in said customer information on said host computer readable medium, to reflect updated upgrade status.

2. The system of claim 1 wherein said set of host computer readable instructions includes instructions for creating route information representing a list of locations where meters need to be upgraded arranged in a logical sequence based on said location information.

3. The system of claim 2 wherein said set of host instructions includes instructions for transmitting said route information to said first computer readable medium.

4. The system of claim 3 wherein said set of host instructions include instructions for converting said route information to a format recognizable by said first computer readable medium prior to transmitting said route information to said first computer readable medium.

5. The system of claim 3 wherein said set of portable computer readable instructions includes instructions for displaying said route information.

6. The system of claim 1 wherein said set of portable computer readable instructions includes:
instructions for displaying a list of options;
instructions for receiving input representing a selection of a option from a user; and
instructions for displaying output in response to said selection of option.

7. The system of claim 1 wherein said receiving instructions include scanning instructions for electronically scanning the updated meter information into said first computer readable medium.

8. The system of claim 1 wherein said set of portable instructions include GPS instructions for communicating with a Global Positioning system to obtain accurate information for locating a utility meter.

9. An automated system for upgrading utility meters from old meters to new meters and maintaining accurate records of the upgrade comprising:
a computer readable medium;
a set of computer readable instructions in communication with said computer readable medium including:
receiving instructions for receiving customer information of customers with old utility meters transmitted from a host computer readable medium;
instructions for receiving upgraded meter information of a new utility meter to replace an old utility meter or a component used to upgrade to the old utility meter; and
instructions for transmitting said upgraded meter information to said host computer readable medium.

10. The system of claim 9 wherein said receiving instructions include scanning instructions for electronically scanning the updated meter information into said computer readable medium.

11. The system of claim 9 wherein said set of computer readable instructions include instructions for displaying route information received from a host computer.

12. The system of claim 9 wherein said set of computer readable instructions includes:
instructions for displaying a list of options;
instructions for receiving input representing a selection of an option from a user; and
instructions for displaying output in response to said selection of option.

13. The system of claim 9 wherein said set of instructions include GPS instructions for communicating with a Global Positioning system to obtain accurate information for locating a utility meter

14. An automated system for upgrading utility meters from old meters to new meters and maintaining accurate records of the work orders comprising:
a host computer readable medium;
a set of host computer readable instructions in communication with said host computer readable medium including:
retrieving instructions for retrieving current utility meter and location information for customers who have old utility meters that need to be upgraded from customer information in communication with said host computer readable medium;
instructions for transmitting said retrieved current utility meter and location information to a second computer readable medium;
instructions for receiving upgraded meter information from said second computer readable medium representing upgraded old meters, and
instructions for updating said current utility information with said upgraded meter information in said customer information on said host computer readable medium, to reflect updated upgrade status.

15. The system of claim 14 wherein said set of host computer readable instructions includes instructions for creating route information representing a list of locations where meters need to be upgraded arranged in a logical sequence based on said location information.

16. The system of claim 15 wherein said set of host instructions includes instructions for transmitting said route information to said first computer readable medium.

17. The system of claim 15 wherein said set of host instructions include instructions for converting said route information to a format recognizable by said first computer readable medium prior to transmitting said route information to said first computer readable medium.

18. A method for maintaining accurate records and processing information associated with utility meters while upgrading utility meters comprising the steps of:
retrieving current utility meter and location information for customers who have old utility meters that need to be upgraded;
transmitting said retrieved current utility meter and location information to a portable computer for upgrading an old meter, updating meter information to a portable computer concerning upgrading of an old utility meter a new utility meter, and transmitting said updated meter information to a host computer;
receiving said updated new meter information from a portable computer representing upgraded, and
updating said current utility information with said updated current utility meter information in said customer information on said host computer readable medium, to reflect updated upgrade status.

19. The method of claim 18 further comprising the step of creating route information representing a list of locations where meters need to be upgraded arranged in a logical sequence.

20. The method of claim 19 further comprising the step of transmitting said route information to a portable computer.

21. The method of claim 19 further comprising the step of converting said route information to a format recognizable by a portable computer prior to transmitting said route information to a portable computer.

22. The method of claim 20 further comprising the step of displaying said route information on a portable computer.

23. The method of claim 18 further comprising the steps of:
displaying a list of options on a portable computer to a user;
receiving input representing a selection of an option from a user; and
displaying output in response to said selection of option.
